(19) United States
(12) Patent Application Publication
(10) Pub. No.: US 2006/0089256 A1
(43) Pub. Date: Apr. 27, 2006

(54) Platinum-rhodium catalyst for automotive exhaust gas

(76) Inventors: Masanori Shimizu, Kakegawa-city (JP); Shingo Sakagami, Kakegawa-city (JP); Eisaku Kondo, Kakegawa-city (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/253,619

(22) Filed: Oct. 20, 2005

(30) Foreign Application Priority Data
Oct. 22, 2004 (JP) 2004-308131

(51) Int. Cl. B01J 23/10

(52) U.S. Cl. 502/304

(57) ABSTRACT

The present invention has as its object the provision of a platinum-rhodium catalyst for automotive exhaust gas wherein the exhaust gas purification catalyst is provided with resistance to lean conditions due to fluctuations in the exhaust gas atmosphere due to fuel cuts of the automobile engine and the catalyst itself is provided with heat resistance due to mounting in the high temperature region right near the engine. Further, the platinum-rhodium catalyst for automotive exhaust gas of the present invention is formed with a catalyst layer from a mixture of a platinum catalyst carrier substance comprised of 95 to 99.9 wt % of a first catalyst carrier substance comprised of either first cerium oxide or activated alumina stabilized by zirconium carrying 0.1 to 5 wt % of platinum, a rhodium catalyst-carrying powder comprised of a second catalyst carrier substance of a rare earth metal element-stabilized zirconium oxide carrying 0.1 to 5 wt % of rhodium, a zirconium-stabilized second cerium oxide not carrying any catalytic precious metal, and a heat resistant inorganic oxide and a binder and is comprised of the catalyst layer and a catalyst carrier substrate carrying the catalyst layer on its surface.

### TECHNICAL FIELD

The present invention relates to a platinum-rhodium catalyst for automotive exhaust gas having a catalyst layer comprised of a platinum catalyst-carrying powder comprised of either zirconium-stabilized first cerium oxide or activated alumina carrying platinum, a rhodium catalyst-carrying powder comprised of zirconium oxide carrying rhodium, a zirconium-stabilized second cerium oxide, and a heat resistant inorganic oxide.

### BACKGROUND ART

Japanese Utility Model Publication (B) No. 5-20435 discloses separately carrying platinum and rhodium for the effect of suppression of sintering of platinum and the effect of promotion of activation of platinum by oxidation of CO by coating a carrier substrate with a catalyst layer not carrying platinum in alumina, carrying platinum in cerium oxide, and carrying rhodium in alumina.

Japanese National Publication No. 2002-518171 discloses a method of avoiding damage due to sulfur compounds exhausted from engine fuel by providing just a slight amount of a catalytic precious metal Rh on a carrier and causing the catalytic precious metal to act on a chemical reaction for reducing nitrogen oxides to nitrogen for reduction. In this method, the catalytic precious metal used is comprised solely of Rh included in a low concentration on the carrier.

Japanese Patent No. 3050566 discloses an exhaust gas purification catalyst composition including a platinum catalyst component dispersed on a carrier of a ceria mass (cerium oxide), a palladium catalyst component, and a heat resistant binder. This exhaust gas purification catalyst composition can function to catalyze both an oxidation reaction between hydrocarbons and carbon monoxide and a reduction reaction of nitrogen oxides.

However, recent automobiles are required to offer improved engine fuel economy, so fuel cuts (F/C) are increased and therefore the fluctuations in the exhaust gas atmosphere are increased. Due to the fluctuations in the exhaust gas-atmosphere, the exhaust gas purification catalyst is required to withstand lean conditions. This catalyst is further mounted in the high temperature region right near the engine, so the exhaust gas purification catalyst is required to be resistant to heat.

As explained above, a catalyst carrier using a precious metal of platinum and rhodium for exhaust gas purification of an automobile is required to purify exhaust gas by a further high temperature. In this high temperature region, the conditions are conducive to alloying of platinum and rhodium with each other. The gas atmosphere processed fluctuates widely. These catalyst carriers are liable to conspicuously reduce the performance in purifying the exhaust gas.

### DISCLOSURE OF THE INVENTION

The platinum-rhodium catalyst of the present invention has as its object to promote the oxidation action of the hydrocarbons and carbon monoxide in the exhaust gas of the engine and promote the reduction action of nitrogen oxides and to suppress alloying of the platinum and rhodium with each other and maintain the initial efficiency without causing a reduction in the catalyst reaction efficiency even if the platinum and rhodium carried on the oxides are exposed to high temperature exhaust gas during the purification action of the exhaust gas and thereby the platinum and rhodium disassociate from the oxides.

Further, the present invention has as its object to prevent the activated alumina or cerium oxide carrying the platinum or the zirconium oxide carrying the rhodium from deteriorating due to the high temperature exhaust gas atmosphere due to exposure to high temperature exhaust gas and maintain the efficiency of carrying the catalytic precious metal carried on the cerium oxide and zirconium oxide without dropping.

Further, it has as its object carrying a plurality of catalytic precious metals on carrier materials with different carrying efficiencies so as to optimize the carrier materials.

The present invention provides, in addition to the activated alumina or cerium oxide 3 carrying a platinum catalyst and the zirconium oxide 8 carrying a rhodium catalyst, a heat resistant inorganic oxide 5 serving as a buffer in the catalyst layer. By the provision of the heat resistant inorganic material, the heat resistant inorganic material acts as a barrier material for preventing alloying of the platinum and rhodium with each other when platinum and rhodium disassociate from the oxides in the high temperature exhaust gas.

Further the present invention can improve the heat resistance of the second cerium oxide 6 itself compared with the first cerium oxide 3 carrying platinum by providing second cerium oxide 6 not carrying platinum alone in the catalyst layer, so can suppress the deterioration of the cerium oxide.

The present invention specifically solves the problem by providing the following Configuration.

The platinum-rhodium catalyst of the present invention 11 is formed with a catalyst layer 9 from a mixture of:

a platinum catalyst carrier substance 7 comprised of 95 to 99.9 wt % of a first catalyst carrier substance 3 comprised of either zirconium-stabilized first cerium oxide or activated alumina carrying 5 to 0.1 wt % of platinum 1,

a rhodium catalyst carrier substance 8 comprised of 95 to 99.9 wt % of a second catalyst carrier substance 4 comprised of a rare earth metal element-stabilized zirconium oxide carrying 0.1 to 5 wt % of rhodium 2,

a zirconium stabilized second cerium oxide 6 not carrying any catalytic precious metal, and

a heat resistant inorganic oxide 5 and

a binder and

is comprised of the catalyst layer and a catalyst carrier substrate 10 carrying the catalyst layer on its surface 10.

Further, the platinum-rhodium catalyst of the present invention 11 preferably contains a platinum catalyst carrier substance 7 comprised of either zirconium-stabilized first cerium oxide 3 or activated alumina carrying platinum 1 in a weight ratio of 0.3 to 3.5 in range with respect to the zirconium-stabilized second cerium oxide 6.

Further, the platinum-rhodium catalyst of the present invention 11 preferably contains the heat resistant inorganic oxide 5 in a weight ratio of 0.04 to 0.56 in range with respect to the weight of the mixture.

Further, in the platinum-rhodium catalyst of the present invention 11, the heat resistant inorganic oxide 5 is preferably at least one type of catalyst of the group of γ-alumina, θ-alumina, α-alumina, zirconia, and a barium compound.

Further, in the platinum-rhodium catalyst of the present invention 11, the zirconium-stabilized first cerium oxide 3 and second cerium oxide 6 preferably have a molar ratio of cerium/zirconium of 51 to 80/49 to 20 in range.

Further, in the platinum-rhodium catalyst of the present invention 11, the rare earth metal element-stabilized zirconium oxide 4 preferably has a molar ratio of zirconium/rare earth metal element of 51 to 95/49 to 5 in range.

The present invention can suitably select the oxides for carrying the platinum and rhodium and thereby suppress disassociation of the platinum and rhodium from the oxides even if the platinum and rhodium catalyst is exposed to high temperature exhaust gas during the purification action of the exhaust gas, therefore alloying of the platinum and rhodium with each other can be kept extremely small and therefore the catalyst reaction efficiency can be maintained over a long time without falling.

Further, the present invention can carry the platinum and rhodium independently by different carrier materials and optimize the carried amounts of the platinum and rhodium so as to cause the precious metal catalysts to disperse as fine particles without an increase in the size of the particles. Therefore, it is possible to provide a catalyst carrier providing the maximum catalytic performance by the smallest content of precious metal catalyst and possible to lower the cost of the precious metal catalyst.

Further, in the present invention, the independently provided second cerium oxide does not carry any precious metal so suppresses the heat deterioration of the cerium and further a heat resistant inorganic oxide is included in the catalyst layer, so these oxides function as heat barrier materials for the oxides carrying the platinum and rhodium and can further improve the heat resistance.

That is, the catalyst layer provided in the platinum-rhodium catalyst of the present invention can suppress the alloying of platinum and rhodium by provision, in addition to the platinum catalyst-carrying powder and rhodium catalyst-carrying powder, of a heat resistant inorganic oxide as a buffer material. The platinum-rhodium catalyst of the present invention can maintain its catalytic performance in automobile, in particular high temperature, exhaust gas for a longer time compared with a conventional catalyst carrier in which no heat resistant inorganic oxide is provided.

Further, the zirconium-stabilized second cerium oxide not containing any platinum, rhodium, or other precious metal does not easily deteriorate at a higher temperature than the first cerium oxide carrying a catalytic precious metal. Therefore, the platinum-rhodium catalyst of the present invention comprised of a catalyst layer including a zirconium-stabilized first cerium oxide carrying a catalytic precious metal and further a zirconium-stabilized second cerium oxide not carrying a catalytic precious metal can maintain the oxygen storage capacity (OSC) high.

### BRIEF DESCRIPTION OF THE DRAWINGS

FIG. 1 is a schematic view of a platinum-rhodium catalyst for automotive exhaust gas comprised of a catalyst carrier substrate carrying a catalyst layer of the present invention on its surface.

FIG. 2 is a schematic view of a platinum-rhodium catalyst for automotive exhaust gas comprised of a catalyst carrier substrate carrying a catalyst layer on its surface of the prior art.

FIG. 3 shows the relationship between the weight ratio CZ/(Pt—CZ) and the time for reaching 50% purification of hydrocarbons from the exhaust gas for Comparative Example 1 (C1) not including a second cerium oxide CZ and Examples 1 to 4 (E1 to E4) including second cerium oxide-CZ and first cerium oxide Pt—CZ carrying platinum.

FIG. 4 shows the relationship between the heat resistant inorganic oxide/other substances and the time for reaching 50% purification of hydrocarbons from the exhaust gas for the platinum catalyst carrying powders of Examples 3 and 5 to 7 (E3 and E5 to E7) having γ-alumina added as an heat resistant inorganic oxide and the platinum catalyst of Comparative Example 2 (C2) not including γ-alumina as a heat resistant inorganic oxide.

### BEST MODE FOR WORKING THE INVENTION

The platinum-rhodium catalyst of the present invention 11 is comprised of a catalyst carrier substrate 10 carrying on its surface a catalyst layer 9 formed from a mixture of a first platinum catalyst-carrying powder 7 comprised of activated alumina or first stabilized cerium oxide 3 carrying platinum 1, a rhodium catalyst-carrying powder 8 comprising stabilized zirconium oxide 4 carrying rhodium 2, a second stabilized cerium oxide 6 provided independently without carrying any catalytic precious metal, and a heat resistant inorganic oxide 5 and a binder.

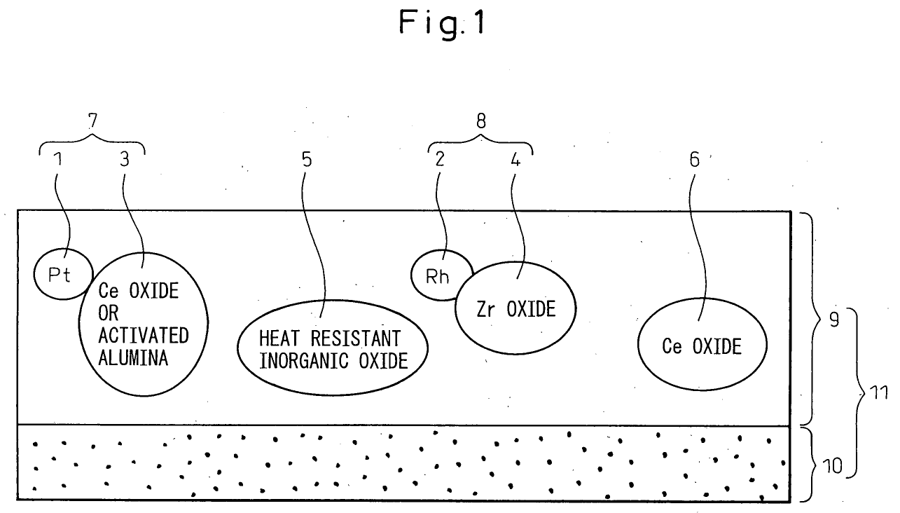

FIG. 1 shows a platinum-rhodium catalyst for automotive exhaust gas comprised of a catalyst carrier substrate carrying a catalyst layer on its surface of the present invention.

The platinum-rhodium catalyst 20 of the prior art is comprised of a catalyst carrier substrate 19 carrying on its surface a catalyst layer 18 formed from a mixture comprised of a platinum catalyst-carrying powder 16 comprised of cerium oxide 14 carrying platinum 12 and a rhodium catalyst-carrying powder 17 comprised of zirconium oxide 15 carrying rhodium 13 and a binder. Therefore, the platinum-rhodium catalyst 20 of the prior art does not include stabilized cerium oxide and heat resistant inorganic oxide provided independently without carrying any catalytic precious metal.

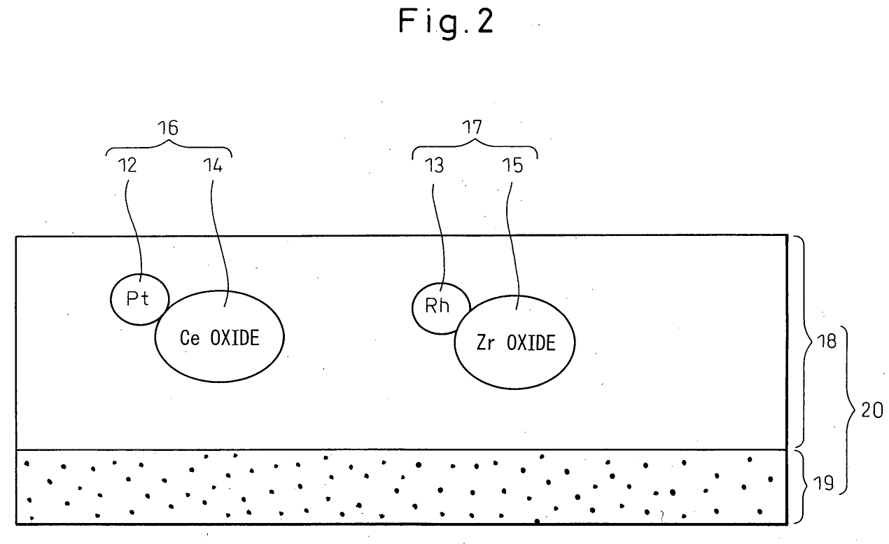

FIG. 2 shows a platinum-rhodium catalyst for automotive exhaust gas comprised of a catalyst carrier substrate carrying a catalyst layer on its surface of the prior art.

The platinum catalyst-carrying powder of the invention of the present application is comprised of a first cerium oxide stable at a high temperature region and carrying platinum. This stabilization of the first cerium oxide in a high temperature region is stabilized by zirconium. This stabilized first cerium oxide is stable thermally even at a high temperature atmosphere reaching 1000° C. right near the engine and suppresses the separation of platinum from this first cerium oxide.

Further, the rhodium catalyst-carrying powder of the invention of the present application is comprised of zirconium oxide stable in a high temperature region and carrying rhodium. This stabilization of the zirconium oxide in a high temperature region is stabilized by a rare earth metal element. This stabilized zirconium oxide, in the same way as the above, is stable thermally even in the high temperature atmosphere right near the engine and suppresses separation of rhodium from this zirconium oxide.

As explained above, in the present invention, by having the stabilized first cerium oxide carry platinum and having the stabilized zirconium oxide carry rhodium, the platinum and rhodium become stable thermally at a high temperature and separation of platinum and rhodium from these oxides is suppressed, so alloying of platinum and rhodium with each other can be suppressed and the initial effect can be maintained without causing a drop in the catalytic efficiency even in this high temperature region.

Further, the platinum-rhodium catalyst of the invention of the present application includes a second stabilized cerium oxide provided alone without carrying a catalytic precious metal and a heat resistant inorganic oxide provided, the second stabilized cerium oxide is superior in heat resistance to the first cerium oxide carrying the catalytic precious metal, and the heat resistant inorganic oxide functions as a heat buffer material between the stabilized cerium oxide carrying the platinum and the zirconium oxide carrying the rhodium, so can suppress separation of platinum and rhodium. As a result, alloying of platinum and rhodium with each other can be suppressed and the initial effect can be maintained without causing a drop in the catalytic efficiency even in this high temperature region.

In the platinum-rhodium catalyst of the present invention, the platinum catalyst-carrying powder carries at least 1.0 wt % of platinum on the first cerium oxide in order to maintain the catalytic performance, carries not more than 5 wt % of platinum on the first cerium oxide in order to disperse fine platinum particles over a wide range and prevent an increase in the particle size, and makes the remainder the first cerium oxide.

Further, in the platinum-rhodium catalyst of the present invention, the rhodium catalyst-carrying powder carries at least 0.1 wt % of rhodium on stabilized zirconium oxide so as to maintain the catalytic performance, carries not more than 5 wt % of rhodium on stabilized zirconium oxide so as to cause fine rhodium particles to disperse over a wide range and prevent an increase of size of the particles, and makes the remainder stabilized zirconium oxide.

In the platinum-rhodium catalyst of the present invention, the heat resistant inorganic oxide is selected from at least one type of catalyst of the group of γ-alumina, θ-alumina, α-alumina, and a barium compound, but may further be replaced by various metal oxides.

The zirconium-stabilized second cerium oxide not carrying any platinum, rhodium, or other precious metal can reduce the deterioration even in a high temperature region compared with the first cerium oxide carrying a catalytic precious metal.

If the molar ratio Ce/Zr of the zirconium-stabilized first and second cerium oxide is made 51/49 or less (if the amount of cerium is made less than 51), the oxygen storage capability (OSC) falls and the hydrocarbon 50% purification time becomes longer. Further, if making the molar ratio Ce/Zr 80/20 or more (if making the amount of zirconium smaller than 20), the heat resistance falls and the hydrocarbon 50% purification time becomes longer.

On the other hand, in the rhodium catalyst-carrying powder of the rare earth metal element-stabilized zirconium oxide, if the molar ratio of the zirconium/rare earth metal element is less than 51/49 (if the amount of zirconium is made less than 51), the effect of zirconium stabilizing the rhodium falls. Further, if the molar ratio of the zirconium/rare earth metal element exceeds 95/5 (if the amount of the rare earth metal element is made smaller than 5), the specific surface area (SSA) of the zirconium itself falls.

### EXAMPLE 1

In the method of Example 1, 75 g of a powder comprised of zirconium-stabilized first cerium oxide was immersed in a platinum nitrate solution, then dried at a temperature of 250° C. over 12 hours so as to prepare a platinum catalyst-carrying powder comprised of a powder of zirconium-stabilized first cerium oxide carrying platinum. This prepared platinum catalyst-carrying powder had 1.1 wt % of platinum carried on said powder of cerium oxide.

Further, in the method of Example 1, 40 g of a powder comprised of zirconium oxide stabilized by cerium as a rare earth metal element was immersed in a rhodium nitrate solution and then dried at a temperature of 250° C. over 12 hours so,as to prepare a rhodium catalyst-carrying powder comprised of a powder of cerium-stabilized zirconium oxide carrying rhodium. The thus prepared rhodium catalyst-carrying powder had 0.5 wt % of rhodium carried on said powder of zirconium oxide.

Further, in Example 1, 75 g of the thus prepared platinum catalyst-carrying powder comprised of the powder of the first cerium oxide carrying platinum, 40 g of the thus prepared rhodium catalyst-carrying powder comprised of the powder of the zirconium oxide carrying rhodium, 40 g of γ-alumina powder as the heat resistant inorganic oxide, 15 g of the zirconium-stabilized second -cerium oxide powder not containing any precious metal, 6 g of a binder, and 200 g of water were mixed and stirred to a slurry state to obtain a catalyst solution. This slurry like catalyst solution was used to cover a monolithic honeycomb carrier forming a carrier substrate to thereby form a catalyst layer on a monolithic honeycomb carrier.

The monolithic honeycomb carrier carrying this catalyst layer was dried at a temperature of 250° C. over 1 hour, then was fired at 500° C. over 1 hour to obtain a platinum-rhodium catalyst formed with the catalyst layer of Example 1.

In the platinum-rhodium catalyst of Example 1, in 170 g of catalyst covering, the first cerium oxide Pt—CZ carrying the platinum accounted for 75 g, the second cerium oxide for 15 g, the zirconium oxide carrying the rhodium for 40 g, and γ-alumina powder as the heat resistant inorganic oxide for 40 g, the weight ratio of the cerium oxide (CZ)/platinum carrying cerium oxide was 0.2, and the 50% purification time was, as shown in Table 2, 36 seconds.

### EXAMPLE 2

In Example 2, a method similar to that of Example 1 was used to prepare a platinum catalyst-carrying powder and rhodium catalyst-carrying powder.

Except for changing the amount of the platinum catalyst-carrying powder carrying the platinum obtained by preparation above to 60 g and the amount of the zirconium-stabilized second cerium oxide powder not containing a precious metal to 30 g, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 2.

In the platinum-rhodium catalyst of Example 2, in 170 g of catalyst covering, the platinum-carrying first cerium oxide Pt-CZ accounted for 60 g, the second cerium oxide for 30 g, the rhodium-carrying zirconium oxide for 40 g, and the heat resistant inorganic oxide γ-alumina for 40 g, the weight ratio of the cerium oxide (CZ)/platinum-carrying cerium oxide was 0.5, and the 50% purification time was, as shown in Table 2, 34 seconds.

### EXAMPLE 3

In Example 3, a method similar to that of Example 1 was used to prepare a platinum catalyst-carrying powder and rhodium catalyst-carrying powder.

Except for changing the amount of the platinum catalyst-carrying powder carrying the platinum obtained by preparation above to 30 g and the amount of the zirconium-stabilized second cerium oxide powder not containing a precious metal to 60 g, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 3.

In the platinum-rhodium catalyst of Example 3, in 170 g of catalyst covering, the platinum-carrying first cerium oxide Pt—CZ accounted for 30 g, the second cerium oxide for 60 g, the rhodium-carrying zirconium oxide for 40 g, and the heat resistant inorganic oxide γ-alumina for 40 g, the weight ratio of the cerium oxide (CZ)/platinum carrying cerium oxide was 2, and the 50% purification time was as shown in Table 2, 33 seconds.

### EXAMPLE 4

In Example 4, a method similar to that of Example 1 was used to prepare and make available a platinum catalyst-carrying powder and rhodium catalyst-carrying powder.

Except for changing the amount of the platinum catalyst-carrying powder carrying the platinum obtained by preparation above to 15 g and the amount of the zirconium-stabilized second cerium oxide powder not containing a precious metal to 75 g, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 4.

In the platinum-rhodium catalyst of Example 4, in 170 g of catalyst covering, the platinum-carrying first cerium oxide Pt—CZ accounted for 15 g, the second cerium oxide for 75 g, the rhodium-carrying zirconium oxide for 40 g, and the heat resistant inorganic oxide γ-alumina for 40 g, the weight ratio of the cerium oxide (CZ)/platinum-carrying cerium oxide was 5, and the 50% purification time was, as shown in Table 2, 37 seconds.

### COMPARATIVE EXAMPLE 1

In Comparative Example 1, a method similar to that of Example 1 was used to prepare a platinum catalyst-carrying powder and rhodium catalyst-carrying powder.

Except for changing the amount of the platinum catalyst-carrying powder carrying the platinum obtained by preparation above to 90 g and eliminating the zirconium-stabilized second cerium oxide powder not containing a precious metal, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Comparative Example 1.

In the platinum-rhodium catalyst of Comparative Example 1, in 170 g of catalyst covering, the platinum-carrying first cerium oxide Pt-CZ accounted for 90 g, the second cerium oxide for 0, the rhodium-carrying zirconium oxide for 40 g, and the heat resistant inorganic oxide γ-alumina for 40 g, the weight ratio of the cerium oxide (CZ)/platinum-carrying cerium oxide was 0, and the 50% purification time was, as shown in Table 2, 40 seconds.

Exhaust Gas Purification of Examples 1 to 4 and Comparative Example 1.

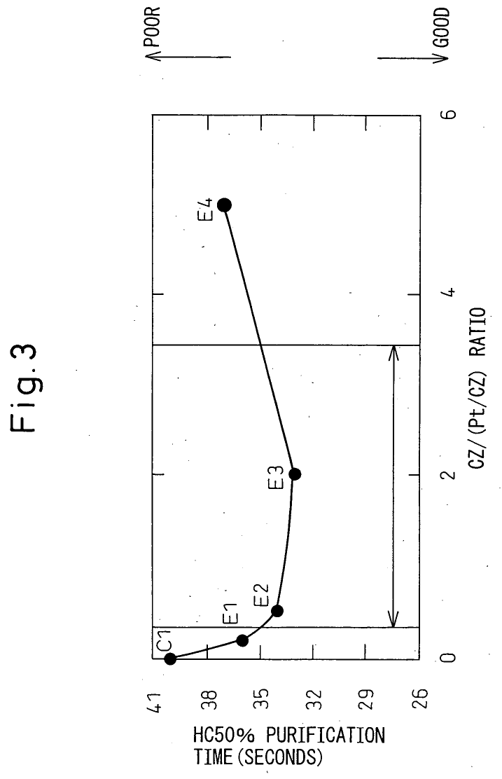

A platinum catalyst-carrying powder Pt—CZ comprised of zirconium-stabilized first cerium oxide powder as an oxide carrying platinum changes greatly in the time until purifying 50% of the hydrocarbons in exhaust gas depending on the weight ratio CZ/(Pt—CZ) with the second cerium oxide CZ not carrying platinum. The times until purifying 50% of the hydrocarbons in exhaust gas for the platinum catalyst-carrying powder changed in the weight ratio of Examples 1 to 4 (E1 to E4) and the platinum catalyst-carrying powder of Comparative Example 1 (C1) (not containing the second cerium oxide CZ), are shown in FIG. 3.

As shown in FIG. 3, the weight ratio CZ/(Pt—CZ) of the second cerium-oxide CZ and the platinum-carrying first cerium oxide Pt—CZ was 0.3 to 3.5 in range, the hydrocarbon 50% purification time was less than 35 seconds, and the fastest, best catalytic performance was exhibited.

Note that when the weight ratio CZ/(Pt—CZ) of the second cerium oxide CZ and platinum-carrying first cerium oxide Pt—CZ was less than 0.3, the drop in the second cerium oxide not carrying any platinum caused the cerium oxide to increasingly deteriorate, so the hydrocarbon 50% purification time exceeded 35 seconds. Therefore, when the weight ratio CZ/(Pt—CZ) was less than 0.3, the catalytic effect was reduced.

Further, when the weight ratio CZ/(Pt—CZ) of the second cerium oxide CZ and the platinum-carrying first cerium oxide Pt—CZ exceeded 3.5, the amount of the first cerium oxide Pt—CZ carrying platinum dropped, the density of carrying the Pt increased, sintering of the platinum occurred, the catalytic function dropped, and the hydrocarbon 50% purification time exceeded 35 seconds. Therefore, when the weight ratio CZ/(Pt—CZ) exceeded 3.5, the catalytic effect was reduced.

### EXAMPLE 5

In Example 5, a method similar to that of Example 1 was used to prepare a platinum catalyst-carrying powder and rhodium catalyst-carrying powder.

Except for changing the amount of the platinum catalyst-carrying powder carrying the platinum obtained by preparation above to 30 g, the amount of the zirconium-stabilized second cerium oxide powder not containing a precious metal to 60 g, and the heat resistant inorganic oxide γ-alumina to 10 g, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 5.

In the platinum-rhodium catalyst of Example 5, in 140 g of catalyst covering, the platinum-carrying first cerium oxide Pt—CZ accounted for 30 g, the second cerium oxide for 60 g, the rhodium-carrying zirconium oxide for 40 g, and the heat resistant inorganic oxide γ-alumina for 10 g, the weight ratio of the heat resistant inorganic oxide γ-alumina/other additives was 0.077, and the 50% purification time was, as shown in Table 2, 34 seconds.

### EXAMPLE 6

In Example 6, a method similar to that of Example 5 was used to prepare a platinum catalyst-carrying powder and rhodium catalyst-carrying powder.

Further, in Example 6, except for changing the amount of the heat resistant inorganic oxide γ-alumina to 70 g, the same procedure and same amounts as in Example 5 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 6.

In the platinum-rhodium catalyst of Example 6, in 200 g of catalyst covering, the platinum-carrying first cerium oxide Pt—CZ accounted for 30 g, the second cerium oxide for 60 g, the rhodium-carrying zirconium oxide for 40 g, and the heat resistant inorganic oxide γ-alumina for 70 g, the weight ratio of the heat resistant inorganic oxide γ-alumina/other additives was 0.538, and the 50% purification time was, as shown in Table 2, 35 seconds.

### EXAMPLE 7

In Example 7, a method similar to that of Example 5 was used to prepare a platinum catalyst-carrying powder and rhodium catalyst-carrying powder.

Further, in Example 7, except for changing the amount of the heat resistant inorganic oxide γ-alumina to 100 g, the same procedure and same amounts as in Example 5 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 7.

In the platinum-rhodium catalyst of Example 7, in 230 g of catalyst covering, the platinum-carrying first cerium oxide Pt—CZ accounted for 30 g, the second cerium oxide for 60 g, the rhodium-carrying zirconium oxide for 40 g, and the heat resistant inorganic oxide γ-alumina for 100 g, the weight ratio of the heat resistant inorganic oxide γ-alumina/other additive was 0.769 and the 50% purification time was, as shown in Table 2, 37 seconds.

### COMPARATIVE EXAMPLE 2

In Comparative Example 2, a method similar to that of Example 5 was used to prepare a platinum catalyst-carrying powder and rhodium catalyst-carrying powder.

Further, in Comparative Example 2, except for eliminating the heat resistant inorganic oxide γ-alumina, the same procedure and same amounts as in Example 5 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Comparative Example 2.

In the platinum-rhodium catalyst of Comparative Example 2, in 130 g of catalyst covering, the platinum-carrying first cerium oxide Pt—CZ accounted for 30 g, the second cerium oxide for 60 g, the rhodium-carrying zirconium oxide for 40 g, and the heat resistant inorganic oxide γ-alumina for 0, the weight ratio of the heat resistant inorganic oxide γ-alumina/other additive was 0, and the 50% purification time was, as shown in Table 2, 40 seconds.

Exhaust Gas Purification of Examples 3 and 5 to 7 and Comparative Example 2.

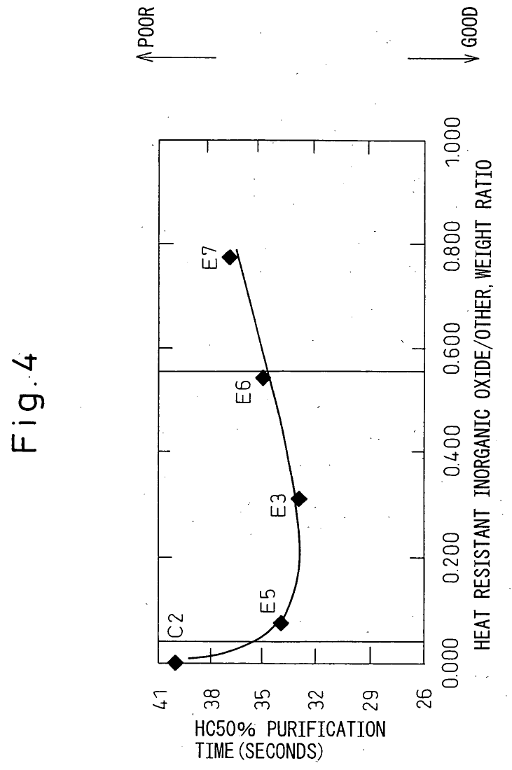

A platinum catalyst-carrying powder changes greatly in the time until purifying 50% of the hydrocarbons in the exhaust gas depending on the weight ratio with the added heat resistant inorganic oxide and other additives. The times until purifying 50% of the hydrocarbons in exhaust gas for the platinum catalyst-carrying powder to which γ-alumina was added as a heat resistant inorganic oxide of Examples 3 and 5 to 7 (E3 and E5 to E7) and the platinum catalyst-carrying powder of Comparative Example 2 (C2) (not containing γ-alumina as a heat resistant inorganic oxide) are shown in FIG. 4.

As shown in FIG. 4, the weight ratio CZ/(Pt—Cz) of the γ-alumina as the heat resistant inorganic oxide and the other additives in the mixture forming the catalyst was 0.04 to 0.56 in range, the hydrocarbon 50% purification time was less than 35 seconds, and the fastest, best catalytic performance was exhibited.

Note that when the weight ratio of the γ-alumina as the heat resistant inorganic oxide and the other additives in the mixture forming the catalyst was less than 0.04, the drop in the γ-alumina as the heat resistant inorganic oxide caused the heat resistant effect to reduce, therefore the hydrocarbon 50% purification time exceeded 35 seconds. Therefore, when the weight ratio of γ-alumina and other additives was less than 0.04, the catalytic effect was reduced.

Further, when the weight ratio of the γ-alumina as the heat resistant inorganic oxide and the other additives in the mixture forming the catalyst exceeded 0.56, the increase in the γ-alumina as the heat resistant inorganic oxide caused the warmup ability to deteriorate, so the hydrocarbon 50% purification time exceeded 35 seconds. Therefore, when the weight ratio of the γ-alumina and other additives exceeded 0.56, the catalytic effect was reduced.

### EXAMPLE 8

In Example 8, using zirconium oxide stabilized by yttrium as a rare earth element instead of zirconium oxide stabilized by cerium as a rare earth metal element, a rhodium catalyst-carrying powder comprised of a powder of yttrium-stabilized zirconium oxide carrying rhodium and a platinum catalyst-carrying powder comprised of zirconium-stabilized first cerium oxide-carrying powder carrying platinum were prepared by the method of Example 1.

Further, in Example 8, except for mixing 40 g of a rhodium catalyst-carrying powder carrying rhodium into the thus prepared powder of yttrium-stabilized zirconium oxide, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 8.

### EXAMPLE 9

In Example 9, except for replacing the γ-alumina with the same amount of θ-alumina, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 9.

### EXAMPLE 10

In Example 10, except for replacing the γ-alumina with the same amount of α-alumina, the same procedure and same amounts as in Example 1 were used for mixture and stirring to prepare a slurry like catalyst solution.

The monolithic honeycomb carrier carrying the catalyst layer by being covered by the thus prepared slurry -like catalyst solution was dried and fired by a method similar to Example 1 to obtain a platinum-rhodium catalyst formed with a catalyst layer of Example 10.

### EXAMPLE 11

In Example 11, except for replacing the γ-alumina with the same amount of zirconia, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 11.

### EXAMPLE. 12

In Example 12, except for replacing the. γ-alumina with the same amount of barium sulfate, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of Example 12.

### COMPARATIVE EXAMPLE 3

In Comparative Example 3, except for eliminating the use of the γ-alumina and the zirconium-stabilized second cerium oxide not carrying any platinum, the same procedure and same amounts as in Example 1 were used for mixture and stirring to prepare a slurry like catalyst solution.

The monolithic honeycomb carrier carrying the catalyst layer by being covered by the thus prepared slurry like catalyst solution was dried and fired by a method similar to Example 1 to obtain a platinum-rhodium catalyst formed with a catalyst layer of. Comparative Example 3.

### EXAMPLE 13

In the method of Example 13, 125 g of a powder comprised of γ-alumina was immersed in a platinum nitrate solution, then dried at a temperature of 250° C. over 12 hours so as to prepare a platinum catalyst-carrying powder comprised of a powder of γ-alumina carrying platinum. This prepared platinum catalyst-carrying powder had 1.1 wt % of platinum carried on a powder of γ-alumina.

Further, in the method of Example 13, 25 g of a powder comprised of zirconium oxide stabilized by cerium as a rare earth metal element was immersed in a rhodium nitrate solution, then dried at a temperature of 250° C. for 12 hours so as to prepare a rhodium catalyst-carrying powder comprising the powder of the cerium-stabilized zirconium oxide carrying rhodium. This prepared rhodium catalyst-carrying powder had 0.5 wt % of rhodium carried on a powder of the zirconium oxide.

Further, in Example 13, a mixture of 125 g of the thus prepared platinum catalyst-carrying powder comprised of a powder of γ-alumina carrying platinum, 25 g of a rhodium catalyst-carrying powder comprised of a powder of the thus prepared zirconium oxide carrying rhodium, 40 g of γ-alumina powder as a heat resistant inorganic oxide, 100 g of a zirconium-stabilized second cerium oxide powder not containing a precious metal, 6 g of a binder, and 200 g of water was stirred to a slurry to obtain a catalyst solution. This slurry like catalyst solution was used to cover a monolithic honeycomb carrier forming a carrier substrate to thereby form a catalyst layer on a monolithic honeycomb carrier.

The monolithic honeycomb carrier carrying this catalyst layer was dried at a temperature of 250° C. over 1 hour, then was fired at 500° C. over 1 hour to obtain a platinum-rhodium catalyst formed with the catalyst layer of Example 1.

### EXAMPLE 14

The catalyst solution of Example 14 was prepared in a slurry state by mixing and stirring in the same way as in Example 13 except for replacing the γ-alumina powder with θ-alumina as the heat resistant inorganic oxide not carrying platinum.

The monolithic honeycomb carrier carrying the catalyst layer by being covered by the thus prepared slurry like catalyst solution was dried and fired by a method similar to Example 13 to obtain a platinum-rhodium catalyst formed with a catalyst layer of Example 14.

### EXAMPLE 15

The catalyst solution of Example 15 was prepared in a slurry state by mixing and stirring in the same way as in Example 13 except for replacing the γ-alumina powder with α-alumina as the heat resistant inorganic oxide not carrying platinum.

The monolithic honeycomb carrier carrying the catalyst layer by being covered by the-thus prepared slurry like catalyst solution was dried and fired by a method similar to Example 13 to obtain a platinum-rhodium catalyst formed with a catalyst layer of Example 15.

### EXAMPLE 16

The catalyst solution of Example 16 was prepared in a slurry state by mixing and stirring in the same way as in Example 13 except for replacing the γ-alumina powder with zirconia as the heat resistant inorganic oxide not carrying platinum.

The monolithic honeycomb carrier carrying the catalyst layer by being covered by the thus prepared slurry like catalyst solution was dried and fired by a method similar to Example 13 to obtain a platinum-rhodium catalyst formed with a catalyst layer of Example 16.

### EXAMPLE 17

The catalyst solution of Example 17 was prepared in a slurry state by mixing and stirring in the same way as in Example 13 except for replacing the γ-alumina powder with barium sulfate as the heat resistant inorganic oxide not carrying platinum.

The monolithic honeycomb carrier carrying the catalyst layer by being covered by the thus prepared slurry like catalyst solution was dried and fired by a method similar to Example 13 to obtain a platinum-rhodium catalyst formed with a catalyst layer of Example 17.

### COMPARATIVE EXAMPLE 4

The catalyst solution of Comparative Example 4 was prepared in a slurry state by mixing and stirring in the same way as in Example 13 except for eliminating the use of the γ-alumina powder as the heat resistant inorganic oxide not carrying any platinum and the zirconium-stabilized second cerium oxide not carrying any platinum.

The monolithic honeycomb carrier carrying the catalyst layer by being covered by the thus prepared slurry like catalyst solution was dried and fired by a method similar to Example 13 to obtain a platinum-rhodium catalyst formed with a catalyst layer of Comparative Example 4.

Table 1 shows the types of individual formulations forming the platinum-rhodium catalysts formed in the examples and comparative examples. The platinum-rhodium catalysts of Examples 2 to 7 were comprised of formulations of the same type as the catalyst of Example 1, but the contents of the individual formulations were changed from Example 1. Example 8 replaces the zirconium oxide stabilized by cerium as the rare earth metal element used in Example 1 with zirconium oxide stabilized by yttrium as the rare earth metal element.

TABLE 1

| | | Heat | |
|---|---|---|---|
| | | resistant | |
| | Catalytic | inorganic | |
| Sample | precious metal | oxide | Other mixture |
| Example 1 | Pt—Ce based | γ-alumina | Pt—Ce, Rh—Zr, and |
| | | | Ce oxides |
| Example 9 | Pt—Ce based | θ-alumina | Pt—Ce, Rh—Zr, and |
| | | | Ce oxides |
| Example 10 | Pt—Ce based | α-alumina | Pt—Ce, Rh—Zr, and |
| | | | Ce oxides |
| Example 11 | Pt—Ce based | Zirconia | Pt—Ce, Rh—Zr, and |
| | | | Ce oxides |
| Example 12 | Pt—Ce based | Ba sulfate | Pt—Ce, Rh—Zr, |
| | | | and Ce oxides |
| Comp. Ex. 3 | Pt—Ce based | None | Pt—Ce, Rh—Zr, Ce |
| | | | oxides not present |
| Example 13 | Pt—Al₂O₃ based | γ-alumina | Pt—Al₂O₃, Rh—Zr, |
| | | | and Ce oxides |
| Example 14 | Pt—Al₂O₃ based | θ-alumina | Pt—Al₂O₃, Rh—Zr, |
| | | | and Ce oxides |
| Example 15 | Pt—Al₂O₃ based | α-alumina | Pt—Al₂O₃, Rh—Zr, |
| | | | and Ce oxides |
| Example 16 | Pt—Al₂O₃ based | Zirconia | Pt—Al₂O₃, Rh—Zr, |
| | | | and Ce oxides |
| Example 17 | Pt—Al₂O₃ based | Ba sulfate | Pt—Al₂O₃, Rh—Zr, |
| | | | and Ce oxides |
| Comp. Ex. 4 | Pt—Al₂O₃ based | None | t-Al₂O₃, Rh—Zr |
| | | | oxide, Ce oxide |
| | | | not present. |

Endurance Test

Each of the platinum-rhodium catalysts obtained in the above examples and comparative examples was subjected to an endurance test. The endurance test was conducted by mounting the platinum-rhodium catalyst in a 3 liter displacement gasoline engine. The revolution speed of the engine was set at 3500 rpm. The endurance test was run for 20 hours with the exhaust gas temperature at the inlet side of each platinum-rhodium catalyst set at 800° C. and the exhaust gas temperature of the center of the platinum-rhodium catalyst set at 1050° C.

Each platinum-rhodium catalyst was aged under the following conditions. The aging conditions were a cycle of 60 seconds, control to a stoichiometric air-fuel ratio A/F=14.6 for a period of 20 seconds from the start of this cycle, increase of fuel until 56 seconds, maintenance at the state of the stoichiometric air-fuel ratio A/F=13 from 20 seconds to 26 seconds, and further control to a stoichiometric air-fuel ratio A/F=15.5 for a period from 26 seconds to 60 seconds. During this cycle, the platinum-rhodium catalyst rose in the temperature at the catalyst center from 26 seconds to reach 1050° C. and fell in temperature from 1050° C. under an excess of oxygen from 56 seconds for the endurance test. Next, an evaluation test was conducted using each catalyst subjected to a 20 hour endurance test by the above cycle.

The evaluation test was conducted by mounting each platinum-rhodium catalyst in a 3 liter displacement gasoline engine under conditions setting the exhaust gas temperature to 500° C. at the exhaust gas inlet side of the platinum-rhodium catalyst. The evaluation value was found by measuring the time until reaching a purification rate of the hydrocarbons (HC) of 50%. Table 2 shows the results of the evaluation tests of the platinum-rhodium catalysts of Examples 1 to 17 and Comparative Examples 1 to 4.

TABLE 2

| | Evaluation value Time for reduction of |
|---|---|
| Sample | hydrocarbons by 50% (seconds) |
| Example 1 | 36 |
| Example 2 | 34 |
| Example 3 | 33 |
| Example 4 | 37 |
| Example 5 | 34 |
| Example 6 | 35 |
| Example 7 | 37 |
| Example 8 | 36 |
| Example 9 | 37 |
| Example 10 | 37 |
| Example 11 | 38 |
| Example 12 | 39 |
| Example 13 | 34 |
| Example 14 | 35 |
| Example 15 | 35 |
| Example 16 | 38 |
| Example 17 | 39 |
| Comparative Example 1 | 40 |
| Comparative Example 2 | 40 |
| Comparative Example 3 | 45 |
| Comparative Example 4 | 40 |

The platinum-rhodium catalyst of the present invention promotes the oxidation of hydrocarbons and carbon monoxide and promotes reduction of nitrogen oxides in automotive exhaust gas and can be utilized in particular as a platinum-rhodium catalyst for exhaust gas purification in the high temperature region of an automobile.

1. A platinum-rhodium catalyst for automotive exhaust gas characterized by being formed with a catalyst layer from a mixture of:
a platinum catalyst carrier substance comprised of 95 to 99.9 wt % of a first catalyst carrier substance comprised of either zirconium-stabilized first cerium oxide or activated alumina carrying 5 to 0.1 wt % of platinum,
a rhodium catalyst carrier substance comprised of 95 to 99.9 wt % of a second catalyst carrier substance of a rare earth metal element-stabilized zirconium oxide carrying 0.1 to 5 wt % of rhodium,
a zirconium-stabilized second cerium oxide not carrying any catalytic precious metal, and
a heat resistant inorganic oxide and
a binder and
is comprised of said catalyst layer and a catalyst carrier substrate carrying said catalyst layer on its surface.

2. A platinum-rhodium catalyst as set forth in claim 1 characterized in that said platinum catalyst carrier substance comprised of either zirconium-stabilized first cerium oxide or activated alumina carrying platinum is contained in a weight ratio of 0.3 to 3.5 in range with respect to the zirconium-stabilized second cerium oxide.

3. A platinum-rhodium catalyst as set forth in claim 1 characterized in that said heat resistant inorganic oxide is contained in a weight ratio of 0.04 to 0.56 in range with respect to the weight of said mixture.

4. A platinum-rhodium catalyst as set forth in claim 1 characterized in that said heat resistant inorganic oxide is at least one type of the group of γ-alumina, θ-alumina, Ε-alumina, zirconia, and a barium compound.

5. A platinum-rhodium catalyst as set forth in claim 1 characterized in that the zirconium-stabilized first cerium oxide and second cerium oxide have a molar ratio of cerium/zirconium of 51 to 80/49 to 20 in range.

6. A platinum-rhodium catalyst as set forth in claim 1 characterized in that the rare earth metal element-stabilized zirconium oxide has a molar ratio of zirconium/rare earth metal element of 51 to 95/49 to 5 in range.
